(19) United States
(12) Patent Application Publication
(10) Pub. No.: US 2015/0324879 A1
(43) Pub. Date: Nov. 12, 2015

(54) CHALLENGE-BASED FRAUD DETECTION

(71) Applicant: CarGurus, Inc., Cambridge, MA (US)

(72) Inventors: Yun Lu, Arlington, MA (US); Oliver I. Chrzan, Somerville, MA (US)

(21) Appl. No.: 14/274,228

(22) Filed: May 9, 2014

(51) Int. Cl. G06Q 30/06

(52) U.S. Cl. CPC G06Q 30/0609

(57) ABSTRACT

A challenge-based system is provided for end users or website administrators to confirm the validity of an online listing by initiating requests for photographs of an item in various contexts, preferably contexts that would be difficult to reproduce without possession of the item listed.

### RELATED APPLICATIONS

This application is related to commonly-owned U.S. application Ser. No. 13/906,981 filed on May 31, 2013, the entire content of which is hereby incorporated by reference.

### BACKGROUND

This application generally relates to the handling of potentially fraudulent online listings, and more particularly to a challenge-based technique for fraud detection.

There are a variety of websites that allow users to list items for sale to other users. While these sites have posting and oversight rules to try and prevent fraud, it is still possible for users to engage in a variety of fraudulent behaviors including misrepresenting items or listing items that an offeror does not possess. There remains a need for improved techniques for detecting fraudulent listings.

### SUMMARY

A challenge-based system is provided for end users or website administrators to confirm the validity of an online listing by initiating requests for photographs of an item in various contexts, preferably contexts that would be difficult to reproduce without possession of the item listed.

In one aspect, a method includes: receiving a listing from a user for online sale of an item through a data network, the listing including an image of the item; evaluating the listing for potential fraud; generating a challenge to the user including a request for a second image of the item in a new context responsive to the challenge when fraud is suspected; transmitting the challenge to the user through the data network; receiving a response from the user to the challenge through the data network, the response including the second image; reviewing the second image to obtain a confirmation that the item has been placed in the new context; and withholding the item from online publication until the confirmation is obtained.

In another aspect, a computer program product includes non-transitory computer executable code embodied in a non-transitory computer readable medium that, when executing on one or more computing devices, performs the steps of: receiving a listing from a user for online sale of an item, the listing including an image of the item; evaluating the listing for potential fraud; generating a challenge to the user including a request for a second image of the item in a new context responsive to the challenge when fraud is suspected; transmitting the challenge to the user; receiving a response from the user to the challenge, the response including the second image; reviewing the second image to obtain a confirmation that the item has been placed in the new context; and withholding the item from online publication until the confirmation is obtained.

In yet another aspect, a system includes a memory storing challenge data and a server coupled in a communicating relationship with a data network. The server may be configured to: receive a listing from a user for online sale of an item, the listing including an image of the item; evaluate the listing for potential fraud; generate a challenge to the user based upon the challenge data, the challenge including a request for a second image of the item in a new context responsive to the challenge when fraud is suspected; transmit the challenge to the user through the data network; receive a response from the user to the challenge through the data network, the response including the second image; review the second image to obtain a confirmation that the item has been placed in the new context; and withhold the item from online publication until the confirmation is obtained.

### BRIEF DESCRIPTION OF THE DRAWINGS

The foregoing and other objects, features and advantages of the devices, systems and methods described herein will be apparent from the following description of particular embodiments thereof, as illustrated in the accompanying figures. The figures are not necessarily to scale, emphasis instead being placed upon illustrating the principles of the devices, systems, and methods described herein.

FIG. 1 shows a network context for challenge-based fraud detection.

FIG. 2 is a flowchart of a method for challenge-based fraud detection.

FIG. 3 shows a pre-challenge image of an item offered for sale and a post-challenge image of the item.

FIG. 4 shows a pre-challenge image of an item offered for sale and a post-challenge image of the item.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it will be understood that terms such as “first,” “second,” “above,” “below,” and the like, are words of convenience and are not to be construed as limiting terms.

Described herein are devices and methods for challenge-based fraud detection. It will be understood that while the exemplary embodiments below emphasize the detection and challenging of potential fraudulent data network sale items, other variations that may be used for the detection and challenging of a sale posting are within the scope of this disclosure. All such variations that can be adapted to be use in challenge-based fraud detection as described herein are intended to fall within the scope of this disclosure. It should also be understood that any reference herein to evaluating a listing, generating a challenge, and reviewing a challenge response are intended to refer to any and all such types of processes unless a different meaning is explicitly stated or otherwise clear from the context.

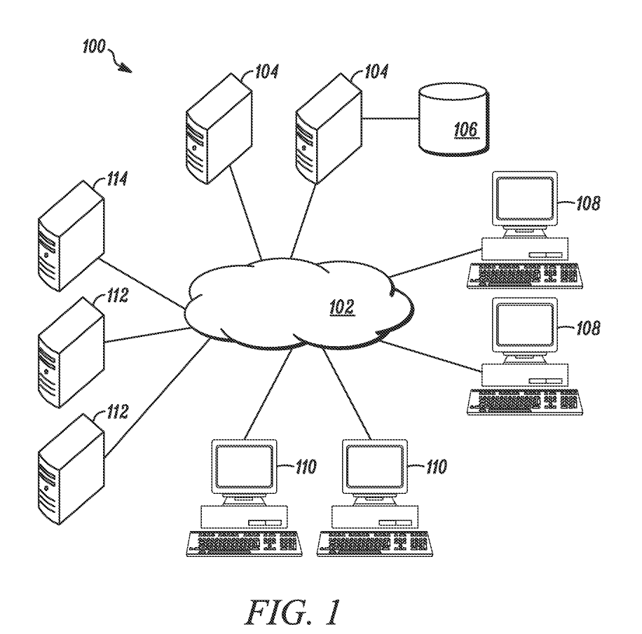

FIG. 1 shows a network context for challenge-based fraud detection. In general, an environment 100 may include a data network 102 interconnecting a plurality of participating devices in a communicating relationship. The participating devices may, for example, include any number of servers 104 which may include memory 106 storing challenge data, user devices 108, purchaser devices 110, web servers 112, and other resources 114.

The data network 102 may be any network(s) or internetwork(s) suitable for communicating data and control information among participants in the environment 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMax-Advanced (IEEE 802.16m)), as well as any of a variety of corporate area or local area networks and other switches, routers, hubs, gateways, and the like that might be used to carry data among participants in the environment 100.

The servers 104 may include memory 106 storage that may store challenge data, a network interface, and a processor or other processing circuitry. In the following description, where the functions or configuration of a server 104 are described, this is intended to include corresponding functions or configuration (e.g., by programming) of a processor of a server 104. In general, the servers 104 (or processors thereof) may perform a variety of processing tasks related to management of an online system as contemplated herein. For example, the servers 104 may manage listings received from one or more of the user devices 108 and present such listings to one or more of the purchaser devices 110. This may include providing a user interface for users to browse or search available listings. The servers 104 may also evaluate listings to identify potential fraud and generate challenges to the user devices 108 (or users) that provided such listings. This may include an evaluation of newly received listings, i.e., as each listing is received, or an evaluation of preexisting listings stored on the servers 104. Where challenges are generated and presented to users, the servers 104 may also review responses automatically, or provide a user interface for manual review by suitable personnel. The server 104 may also include a web server that provides a user interface for web-based access to server functionality by the user devices 104 and purchaser devices 110.

User preferences may be usefully stored at the server 104 to facilitate autonomous access to server content such as data stored in the memory 106 of the server. For example, a server 104 may store a user's identification, payment information, shipping information, and the like. These preferences may be used to facilitate transactions once a sale of a listed item is initiated.

In one aspect, the processor of the server 104 may be configured to store a plurality of sale items and purchases submitted to the web server in a log and to provide an analysis of these activities based on the log. This may include any type of analysis that might be useful to participants in the environment 100, or for detecting potential fraud. For example, the analysis may include tracking of the popularity of particular items, pending sales, volume of sales by a user, volume of purchases, purchaser satisfaction information, previous challenges by user or item type, and the like.

Fraud detection may be based on aspects of a listing such as a price that appears unrealistic (e.g., “too good to be true”) or any other substantial mismatch between a predicted price and an offering price for an item, the age of a listing, metadata associated with an uploaded image, a listing of an obscure or rare vehicle or other item, and so forth. Similarly, inferences available from the content of a listing may indicate potential fraud, such as where the text of a listing refers to wire transfers or other unusual financial requests or requirements, or where vehicle identification information matches a vehicle recently sold in a different geographic region, or where a listing has been explicitly flagged as potentially fraudulent by another user. Potentially fraudulent listings may also or instead be flagged, for example, based on characteristics of a particular user providing a listing, e.g., based upon the use of a password associated with prior fraud, a user history, a user name pattern, an e-mail address pattern, a country of origin, and so forth. As another example, fraud candidates may be flagged based on network data related to a listing such as an IP address of a source of a listing, the use of a proxy network or other anonymizing software to obscure the identity or network address of a source of a listing, and so forth. More generally, any criterion or combination of criteria that may be usefully employed to automatically identify candidates for potential fraud may be used to detect possible fraud as contemplated herein.

With respect to the challenge-based fraud detection systems contemplated herein, the memory 106 may store any data useful for identifying potentially fraudulent listings, or for creating challenges when potential fraud is detected. The server 104 may be configured to automatically select from among a number of different challenges for an appropriate challenge data to be sent to the user for the verification of an item for sale. This may, for example, be based on the type of fraud suspected, a sales or listing history for the entity listing the item (e.g., to ensure that the same challenge is not issued twice to a user), the type of item, and so forth.

User devices 108 may in general be any devices within the environment 100 operated by users to post advertisement of items for sale to the server 104. This may include desktop computers, laptop computers, network computers, tablets, smart phones, or any other computing device that can participate in the environment 100 as contemplated herein. Each user device 108 generally provides a user interface, which may include a graphical user interface and/or text or command line to interface with the environment 100. The user interface may be maintained by a locally executing application on one of the user devices 108 that receives data and status information from, e.g., servers 104, web servers 112, other resources 114, and purchaser devices 110 concerning the item sale. In other embodiments, the user interface may be remotely served and presented on one of the user devices 108, such as where a server 104 includes a web server that provides information through one or more web pages or the like that can be displayed within a web browser or similar client executing on one of the user devices 108.

Purchaser devices 110 may be other devices within the environment 100 operated by purchasers to buy items for sale from the server 104. While purchaser devices 110 are shown as separate devices within the network 102, it should be appreciated that the user device 108 and purchaser devices 110 may be the same device, e.g., with a user using the same device for both selling and purchasing. The purchaser device 110 may include desktop computers, laptop computers, network computers, tablets, smart phones, or any other computing device that can participate in the environment 100 as contemplated herein. Each purchaser device 110 generally provides a user interface, which may include a graphical user interface and/or text or command line to interface with the environment 100. The user interface may be maintained by a locally executing application on one of the purchaser devices 110 that receives data and status information from, e.g., servers 104, web servers 112, other resources 114, and user devices 108 concerning the item sale. In other embodiments, the user interface may be remotely served and presented on one of the purchaser devices 110, such as where a server 104 includes a web server that provides information through one or more web pages or the like that can be displayed within a web browser or similar client executing on one of the purchaser devices 110.

One or more web servers 112 may provide web-based access to and from any of the other participants in the environment 100. While depicted as a separate network entity, it will be readily appreciated that a web server 112 may be logically or physically associated with one of the other devices described herein, and may, for example, provide a user interface for web access to one of the servers 104 (or memory 106 coupled thereto), for example by the user devices 108 or purchaser devices 110 described herein, in a manner that permits user interaction through the data network 102.

The other resources 114 may include any other software or hardware resources that may be usefully employed in network applications as contemplated herein. For example, the other resources 114 may include payment processing servers or platforms used to authorize payment for items. As another example, the other resources 114 may include social networking platforms that may be used, e.g., to share item information, sale information, or purchase information according to a user's social graph. In another aspect, the other resources 114 may include certificate servers or other security resources for third party verification of identity, encryption or decryption services, and so forth.

It will be readily appreciated that the various components of the network environment 100 described above may be arranged and configured to support item sales, purchase, and challenge-based fraud detection. For example, in one aspect there is disclosed herein the server 104 coupled in a communicating relationship with the data network 102, where the server 104 is configured to receive a listing from a user device 108 for online sale of an item, the listing may include an image of the item. The server 104 may be further configured to evaluate the listing for potential fraud and, when fraud is suspected, to generate a challenge to the user based upon the challenge data stored in memory 106. The challenge may include a request for a second image of the item in a new context, such as positioned in, on, or adjacent to another item, or with another item in, on, or adjacent to the item. The server 104 may transmit the challenge to the user through the data network 102 and may also receive a challenge response from the user through the data network 102. The response may include the second image, which may be reviewed automatically or manually to obtain a confirmation that the item has been placed in the new context. The server 104 may withhold the item from online publication until the confirmation of the new context is obtained.

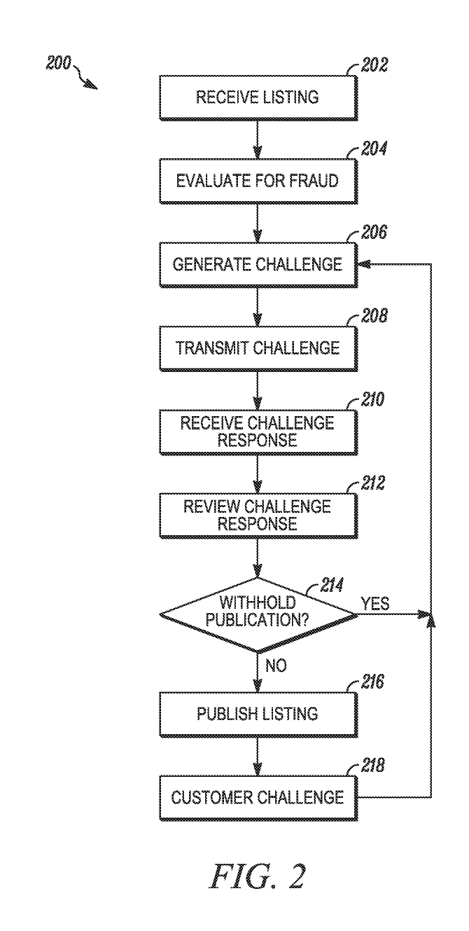

FIG. 2 is a flowchart of a method 200 for challenge-based fraud detection. In general, the method may be deployed in a network environment such as that described above, and may be coordinated by a server or the like that provides business logic, source data, and so forth to support automated, semi-automated, or manual detection and challenge-based resolution. These challenge-based fraud detection techniques may be used to evaluate item listings on a data network, or in any other computing environment where potential fraud related to a physical item is detected. Generally, an initial image of an item is received, and then a challenge is presented to the source of the item to photograph the image in some new context in order to verify that the source actually has possession of the item.

As shown in step 202, the method 200 may begin with receiving a listing from a user for an online sale of an item through a data network. The item may be any good suitable for listing online, including without limitation a vehicle (e.g., car, truck, motorcycle, etc.), consumer electronics, a book, a toy, and so forth. The listing may be posted to a server along with any related information such as descriptive metadata, images, an asking price, any terms or conditions of sale, and so forth.

As shown in step 204, the method 200 may include evaluating the received listing for potential fraud. This may include any suitable form of manual or automated evaluation. In an embodiment, the evaluation may be performed automatically by the server prior to online publication of the item. If the automatic evaluation determines there is potential fraud involved in the listing of the item, a notification may be provided to a human agent for further review of the listing.

A variety of techniques for automated fraud detection may be suitably employed. This may, for example, include an analysis of any suitable data related to the listing including an age of the listing, a price, a description, seller reputation, and so forth. In one aspect, the automatic evaluation may be a determination that the listed item does not have an associated image, in which case, an initial image may be requested as a part of the listing evaluation.

In another aspect, the item may be compared to previously listed items and comparisons may be made based on listing text and images from the plurality of previous item listings in an effort to identify similarities to one of the previously listed items. If it is determined that the proposed listing item may be the same as at least one of the plurality of previously listed items, particularly in cases where an item is relatively unique (e.g., not a commodity item), potential fraud may be indicated. In another aspect, the user offering the item may be analyzed to determine if the user has previously provided fraudulent items for sale. Other information such as a sending IP address, the use of a proxy server, a geographic region from which the listing item was received, a time of day in which the listing item was received, and so forth may also or instead be used in evaluating new listings.

The evaluation may be performed automatically, in which case a challenge may be automatically generated, or a notification may be transmitted to a human agent for review and disposal, either by accepting the automatically detected listing or by requesting that a challenge be presented.

As shown in step 206, the method may include generating a challenge to the user. The challenge may include a request for a second image of the item in a new context when fraud is suspected. The new context may include a second item juxtaposed in a predetermined manner with the item. For example, this may include placing the item on, in, or near another item, or by placing another item on, in, or near the item offered for listing. Thus for example, where the item is a vehicle, the challenge may request an image of a towel placed on the hood of the vehicle, or the challenge may request an image of today's newspaper placed on the dashboard or the passenger seat. The second item may be a randomly selected household item, e.g., selected from commonly available items such as a coffee mug, a towel, a t-shirt, and so forth. The second item may suitably include a person, such as the offeror or any other person. Thus for example, the challenge may request an image of a person holding the item in front of today's newspaper, or where the item is a vehicle, an image of a person sitting in the driver's seat of the vehicle.

In another aspect, the new context may include a location for the item. This may be any generic location such as on a chair, on a sidewalk, in front of a window, and so forth, as well as a more specific location such as in front of a specific building (e.g., a town hall or the like) near a location where the item is offered for sale.

The challenge may be selected using any suitable techniques. Where a human agent is processing the item, the method 200 may include manually selecting from among a plurality of candidate challenges such as a number of challenges stored in a challenge database, or by requesting a random selection from a database of candidate challenges or the like. Similarly, selection criteria may be employed based on, e.g., the type of item being listed, a history of the offeror, a location of the offered item, and so forth. In one aspect, the method 200 may include automatically selecting the challenge from among a plurality of candidate challenges based on a type of the item or any other suitable criteria.

As shown in step 208, the method 200 may include transmitting the challenge to the user through the data network. The transmitted challenge may include the original image, the challenge item identification for the second image, instructions for the requirements of the second image, and any other requirement for the second image.

As shown in step 210, the method may include receiving a response from the user to the challenge through the data network. The response may include a second image responsive to the challenge. For example, a challenge response may be received from the user through the data network 102. The response may include the challenge second image and any other information that was required by the challenge. In one aspect, the response may include a refusal to provide the challenge second image, or an alternative to the challenge, where such refusal or alternative may be reviewed automatically or manually by the challenger or other human agent (or any combination thereof). In response to the refusal or alternative, another challenge may be issued, the listing may be removed, the challenge may be re-sent (i.e., the refusal or alternative may be denied completely), or another similar responsive action may be taken.

As shown in step 212, the method 200 may include reviewing the second image to obtain confirmation that the item has been placed in the new context, and more specifically that the second image includes the challenge item in the appropriate context as requested in the transmitted challenge. As part of the confirmation, the second image may be reviewed to verify that the challenge item is juxtaposed to the original item in a predetermined manner within the second image. The review may in general be performed automatically, e.g., through image processing, or manually, e.g., through review by a human agent, or some combination of these.

As shown in step 214, the method may include withholding the item from online publication unless or until a confirmation is obtained. More specifically, a decision may be made as to whether the second image satisfies the challenge presented above. If the image does not satisfy the challenge, as determined through either automatic review, manual review, or some combination of these, then publication may be withheld and the method 200 may return to step 206 where a new challenge is initiated. If the image does satisfy the challenge, then publication may not be withheld, and the method 200 may proceed to step 216 where the listing is published for viewing by others on the network.

As shown in step 216, the method 200 may include publishing the listing. Publishing the listing may include publication of the listing online or as otherwise described herein. The listing may be published for the first time, or it may be a re-publishing of the listing after a customer challenge or the like.

As shown in step 218, the method 200 may include receiving a customer challenge after the item is published. In one aspect, evaluating the listing for potential fraud as described above may also include evaluation by a potential customer after publication of the listing, e.g., online publication. In such circumstances, the potential customer may initiate a challenge using the techniques described above. Thus generating the challenge as contemplated above may include receiving a selection of the challenge from the potential customer, and the potential customer may personally review a response to determine whether the response is satisfactory before offering to purchase the item. In this manner, an end user system may support on-demand, challenge-based verification for online shoppers.

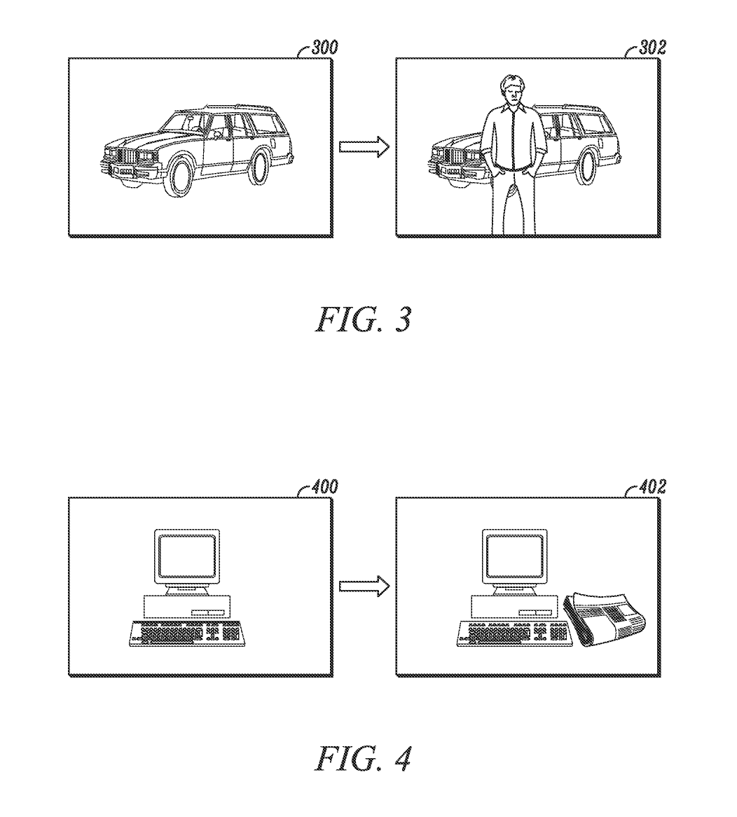

FIG. 3 shows a pre-challenge image of an item and a post-challenge image of the item as described herein. In particular, an offeror may provide an image 300 of a vehicle prior to a challenge, and the challenge may request a second image of the item in a new context (the “post-challenge item”), such as with a person in front of the vehicle. A responsive image 302 may be provided and evaluated for authenticity using any suitable techniques. In one aspect, the item may be automatically analyzed for evidence of tampering, such as where the visible item in the new image appears to have been copied from the earlier image and manipulated into the new context or where other photo-editing techniques appear to have been utilized.

FIG. 4 shows a pre-challenge image of an item and a post-challenge image of the item. In particular, a first image 400 may be provided of a computer offered for sale. A challenge may be presented to the offeror to provide an image of the computer with a newspaper placed in front of it, such as a newspaper with a current date. The offeror may respond with a second image 402 responsive to the challenge showing the computer in the new context. It should be understood that FIGS. 3 and 4 are presented as non-limiting examples of pre-challenge and post-challenge images and that any suitable contexts may be used for challenge-based and image-based verification of listings as contemplated herein.

It will be readily appreciated that the above steps are provided by way of example and not limitation, and that numerous variations are possible including additions, omissions, and or variations of the steps recited above. All such variations as would be appreciated by one of ordinary skill in the art are intended to fall within the scope of this disclosure.

It will also be understood that this disclosure includes an apparatus for performing the methods described above. Thus in one aspect there is disclosed challenge-based fraud detection that includes a network interface configured to receive an item listing, review and evaluate the listing item for potential fraud, generate a challenge to the listing user, and review the challenge response received from the user.

Many of the above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory, any of which may serve as the controller described above or supplement processing of the controller with additional circuitry. This may also, or instead, include one or more application specific integrated circuits, programmable gate arrays, programmable array logic components, or any other device(s) that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
receiving a listing from a user for online sale of an item through a data network, the listing including an image of the item;
evaluating the listing for potential fraud;
generating a challenge to the user including a request for a second image of the item in a new context responsive to the challenge when fraud is suspected;
transmitting the challenge to the user through the data network;
receiving a response from the user to the challenge through the data network, the response including the second image;
reviewing the second image to obtain a confirmation that the item has been placed in the new context; and
withholding the item from online publication until the confirmation is obtained.

2. The method of claim 1 wherein evaluating the listing for potential fraud includes automatically evaluating the listing prior to online publication and providing a notification to a human agent when the listing is potentially fraudulent.

3. The method of claim 1 wherein generating the challenge includes manually selecting from among a plurality of candidate challenges.

4. The method of claim 1 wherein generating the challenge includes automatically selecting the challenge from among a plurality of candidate challenges based on a type of the item.

5. The method of claim 1 wherein reviewing the second image includes manually reviewing the second image.

6. The method of claim 1 wherein reviewing the second image includes automatically reviewing the second image.

7. The method of claim 1 wherein the new context includes a second item juxtaposed in a predetermined manner with the item.

8. The method of claim 7 wherein the second item is on the item.

9. The method of claim 7 wherein the second item is in the item.

10. The method of claim 7 wherein the second item includes a person.

11. The method of claim 7 wherein the second item includes a randomly selected household item.

12. The method of claim 1 wherein the new context includes a location for the item.

13. The method of claim 1 wherein evaluating the listing for potential fraud includes evaluating by a potential customer after online publication of the listing, and wherein generating the challenge includes receiving a selection of the challenge from the potential customer.

14. A computer program product comprising non-transitory computer executable code embodied in a non-transitory computer readable medium that, when executing on one or more computing devices, performs the steps of:
receiving a listing from a user for online sale of an item, the listing including an image of the item;
evaluating the listing for potential fraud;
generating a challenge to the user including a request for a second image of the item in a new context responsive to the challenge when fraud is suspected;
transmitting the challenge to the user;
receiving a response from the user to the challenge, the response including the second image;
reviewing the second image to obtain a confirmation that the item has been placed in the new context; and
withholding the item from online publication until the confirmation is obtained.

15. The computer program product of claim 14 wherein evaluating the listing for potential fraud includes automatically evaluating the listing prior to online publication and providing a notification to a human agent when the listing is potentially fraudulent.

16. The computer program product of claim 14 wherein generating the challenge includes automatically selecting the challenge from among a plurality of candidate challenges based on a type of the item.

17. The computer program product of claim 14 wherein reviewing the second image includes automatically reviewing the second image.

18. The computer program product of claim 14 wherein the new context includes a second item juxtaposed in a predetermined manner with the item.

19. The computer program product of claim 14 wherein evaluating the listing for potential fraud includes evaluating by a potential customer after online publication of the listing, and wherein generating the challenge includes receiving a selection of the challenge from the potential customer.

20. A system comprising:
a memory storing challenge data; and
a server coupled in a communicating relationship with a data network, the server configured to receive a listing from a user for online sale of an item, the listing including an image of the item; to evaluate the listing for potential fraud; to generate a challenge to the user based upon the challenge data, the challenge including a request for a second image of the item in a new context responsive to the challenge when fraud is suspected; to transmit the challenge to the user through the data network; to receive a response from the user to the challenge through the data network, the response including the second image; to review the second image to obtain a confirmation that the item has been placed in the new context; and to withhold the item from online publication until the confirmation is obtained.
